(19) United States
(12) Patent Application Publication
(10) Pub. No.: US 2021/0081253 A1
(43) Pub. Date: Mar. 18, 2021

(54) GATHERING DATA OF A DISTRIBUTED SYSTEM BASED ON DEFINED SAMPLING INTERVALS THAT HAVE BEEN RESPECTIVELY INITIATED BY SUCH SYSTEM TO MINIMIZE CONTENTION OF SYSTEM RESOURCES

(71) Applicant: EMC IP Holding Company LLC, Hopkinton, MA (US)

(72) Inventor: Austin Voecks, Bainbridge, WA (US)

(21) Appl. No.: 16/570,757

(22) Filed: Sep. 13, 2019

(51) Int. Cl. G06F 9/50; G06F 16/174; G06F 16/31; G06F 9/48

(52) U.S. Cl. CPC G06F 9/5083; G06F 9/4881; G06F 16/325; G06F 16/1748

(57) ABSTRACT

Gathering data of a distributed system based on defined sampling intervals that have been respectively initiated by such system to minimize contention of system resources is presented herein. The distributed system comprises a configuration file that defines sampling intervals for respectively obtaining defined attributes of respective defined resource types of respective compute resources of a group of storage nodes of a storage cluster; and a secure remote services component that determines, based on the configuration file, different times to initiate the respectively obtaining the defined attributes of the respective defined resource types according to the sampling intervals, and at the different times, initiates the respectively obtaining the defined attributes of the respective defined resource types according to the sampling intervals.

### TECHNICAL FIELD

The subject disclosure generally relates to embodiments for gathering data of a distributed system based on defined sampling intervals that have been respectively initiated by such system to minimize contention of system resources.

### BACKGROUND

Conventional storage technologies utilize simple scheduling algorithms to gather unstructured data of a system on a coarse-grained scheduling basis. For example, Unix-based cron is a time-based job scheduler that can be manually programmed, using a crontab file, to run shell commands periodically at fixed times, e.g., each line of the crontab file specifying a shell command to gather the data, e.g., yearly, monthly, weekly, daily, or hourly,

In this regard, as the amount of different shell commands being specified in the crontab file increases, it becomes manually prohibitive to separate execution times of such commands—inevitably resulting in shell commands initiating execution at the same time and overloading system resources. Consequently, conventional storage technologies have had some drawbacks, some of which may be noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a distributed file system that gathers data of system resources based on defined sampling intervals that have been respectively initiated by such system to minimize contention of the system resources, in accordance with various example embodiments;

FIG. 2 illustrates another block diagram of a distributed file system that gathers data of system resources based on defined sampling intervals that have been respectively initiated by such system to minimize contention of the system resources, in accordance with various example embodiments;

FIG. 3 illustrates a block diagram of a configuration file representing defined attributes of respective defined resources of the distributed system and defined intervals for sampling the defined attributes, in accordance with various example embodiments;

FIG. 4 illustrates a block diagram of a secure remote services component comprising a deduplication component, in accordance with various example embodiments;

FIG. 5 illustrates a flow chart of a method associated with gathering data of system resources based on defined sampling intervals that have been respectively initiated by such system to minimize contention of the system resources, in accordance with various example embodiments;

FIG. 6 illustrates a flow chart of another method associated with gathering data of system resources based on defined sampling intervals that have been respectively initiated by such system to minimize contention of the system resources, in accordance with various example embodiments;

FIGS. 7-9 illustrate flow charts of a method associated with a deduplication component that facilitates reducing system costs associated with communicating results that haven't changed between sampling periods, in accordance with various example embodiments; and

FIG. 10 illustrates a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, although conventional storage technologies support scheduling of processes to gather information, it is untenable to manually separate when a large number of the processes will be executed—resulting in spike(s) in use of system resources. On the other hand, various embodiments disclosed herein can minimize contention of system resources by initiating respective gathering of system data at different times.

For example, a system, e.g., a distributed file system, can comprise a processor; a configuration file that defines sampling intervals for respectively obtaining defined attributes of respective defined resource types of respective compute resources of a group of storage nodes of a storage cluster; and a memory that stores executable components that, when executed by the processor, facilitate performance of operations by the system, the executable components comprising: a secure remote services component that determines, based on the configuration file, different times to initiate the respectively obtaining the defined attributes of the respective defined resource types according to the sampling intervals; and at the different times, initiates the respectively obtaining the defined attributes of the respective defined resource types according to the sampling intervals.

In embodiment(s), the defined attributes comprise a performance attribute of a defined resource type of the respective defined resource types, a usage attribute of the defined resource type, and/or a configuration attribute of the defined resource type.

In an embodiment, the defined resource type comprises the storage cluster or a storage node of the group of storage nodes.

In one embodiment, the performance attribute comprises a computer processing unit use of the defined resource type, an average computer processing unit use of the defined resource type, or a resource health score of the defined resource type.

In another embodiment, the usage attribute comprises a total storage capacity of the defined resource type, a storage amount of the total storage capacity that is being used, a total memory capacity of the defined resource type, a memory amount of the total memory capacity that is being used, or an uptime of the defined resource type representing a duration of time that the defined resource type has been in use.

In yet another embodiment, the configuration attribute comprises a number of computer processing units corresponding to the defined resource type, a network protocol (e.g., network file system (NFS) protocol, file transfer protocol (FTP), server message block (SMB) protocol, etc.) attribute of the defined resource type, or a distributed file system (DFS) of the defined resource type.

In an embodiment, the respective compute resources comprise respective computer processing units, respective volatile memory devices, and respective memory devices. In this regard, the defined resource type comprises a group of computer processing units of the respective computer processing units, a group of volatile memory devices of the respective volatile memory devices, or a group of memory devices of the respective memory devices.

In one embodiment, a storage node of the group of storage nodes has been elected, based on an election algorithm, as a master storage node comprising the secure remote services component. In this regard, the master node is elected, selected, etc. from the cluster to coordinate, via respective platform application programming (PAPI) interfaces of the group of storage nodes, collecting, gathering, and reporting of the defined attributes.

In another embodiment, the secure remote services component determines, based on the configuration file, random times, e.g., using a random number function, to initiate the respectively obtaining the defined attributes of the respective defined resource types according to the sampling intervals.

In an embodiment, the secure remote services component further: obtains unstructured data corresponding to the defined attributes, and creates respective structured data representing the defined attributes, the respective structured data comprising the unstructured data and respective metadata representing the unstructured data.

In one embodiment, the respective structured data comprises a storage cluster identifier representing the storage cluster, an attribute identifier representing a defined attribute of the defined attributes, and/or a period of time during which the defined attribute was obtained by the secure remote services component.

In another embodiment, the executable components further comprise an analysis component that receives, from the secure remote services component, the respective structured data, and in response to a query for a defined attribute of the defined attributes being received from a client service device (e.g., associated with a client service of a client of the system, distributed file system, etc.), sends a portion of the respective structured data representing the defined attribute to the client service device.

In yet another embodiment, the remote services component further comprises: a deduplication component that, in response to first unstructured data, e.g., later referred to as previously collected unstructured data, corresponding to a defined attribute of the defined attributes of a defined resource type of the respective defined resource types being obtained via a first sampling interval of the sampling intervals, performs a hash function on the first unstructured data to obtain a first hash value, stores the first hash value in a first portion of the memory, e.g., a first part of a hash table, and stores a first time that the first hash value was obtained in a second portion of the memory, e.g., a second part of the hash table.

Further, in response to second unstructured data, e.g., latest collected unstructured data, corresponding to the defined attribute being obtained via a second sampling interval of the sampling intervals, the deduplication component performs the hash function on the second unstructured data to obtain a second hash value, and in response to the first hash value of the previously collected unstructured data being determined to be equal to the second hash value of the latest collected unstructured data, the deduplication component stores a second time that the second hash value was obtained in the second portion of the memory; otherwise, in response to the first hash value being determined to be different than the second hash value, the deduplication component stores the second hash value in the first portion of the memory, and stores the second time in the second portion of the memory.

In one embodiment, a method can comprise: obtaining, from a configuration file by a system comprising a processor, defined attributes of respective defined resource types of respective compute resources of a group of storage nodes of a storage cluster and defined sampling intervals for determining the defined attributes; determining, by the system, distinct times to sample, based on the defined sampling intervals, the defined attributes; and sampling, by the system at the distinct times, the defined attributes.

In another embodiment, the sampling comprises: obtaining, at the distinct times via respective platform application programming (PAPI) interfaces of the storage nodes, respective unstructured data corresponding to the defined attributes; and generating respective structured data representing the defined attributes—the respective structured data comprising the respective unstructured data and metadata representing the respective unstructured data.

In yet another embodiment, the method further comprises: in response to a query for a defined attribute of the defined attributes being determined to be received from a client service device, sending, by the system, a portion of the respective structured data representing the defined attribute directed to the client service device.

Another embodiment can comprise a machine-readable storage medium comprising instructions that, in response to execution, cause a storage node comprising a processor to perform operations, comprising: retrieving, from a configuration file of the file system, defined attributes of respective defined resources of the file system and defined intervals for sampling the defined attributes; determining disparate times to initiate the sampling the defined attributes of the respective defined resources based on the defined intervals; and based on the disparate times, initiating the sampling the defined attributes of the respective defined resources based on the defined intervals to obtain respective unstructured data corresponding to the defined attributes.

In an embodiment, operations can further comprise: in response to the sampling, generating structured data comprising the respective unstructured data and metadata representing the unstructured data.

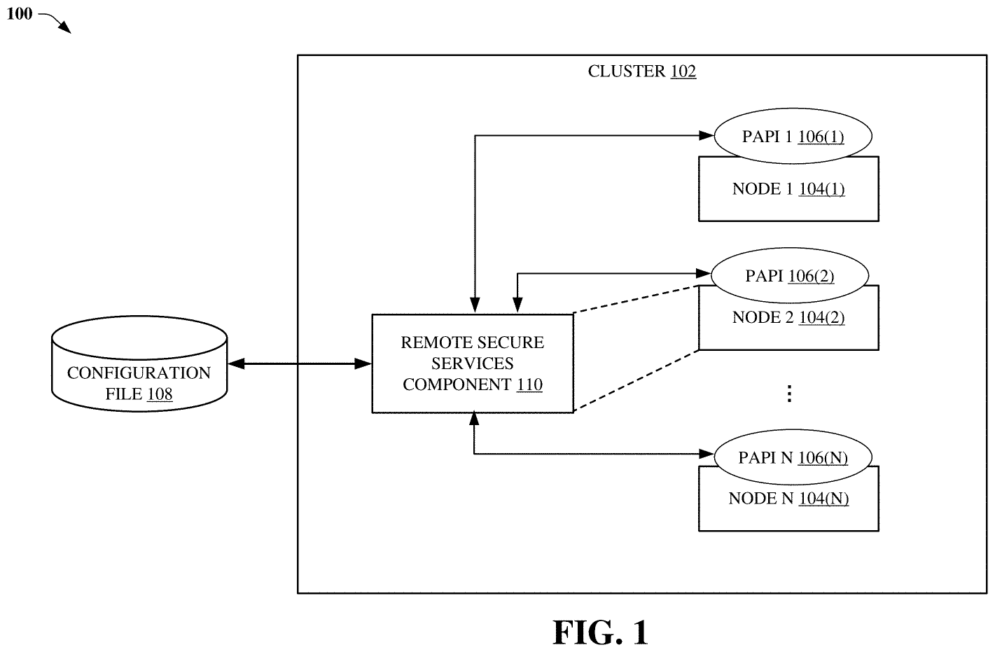

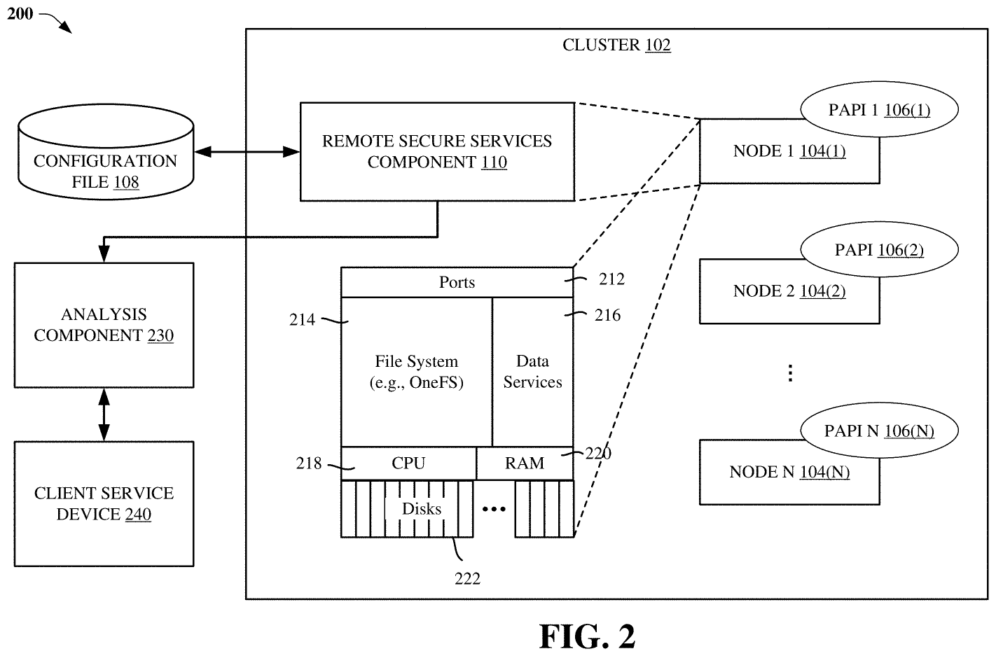

As described above, conventional storage technologies have had some drawbacks with respect to overloading system resources when scripts are used to perform a large number of monitoring processes. In contrast, and now referring to FIG. 1 and FIG. 2, various embodiments described herein can minimize contention of system resources by initiating respective gathering of system data at different times. In this regard, a distributed file system (100) can comprise a parallel distributed networked file system, e.g., OneFS™ file system (214) provided by Dell EMC® Isilon Systems, e.g., utilizing a FreeBSD based operating system. In embodiment(s), the distributed file system can comprise a host server, a client server, etc. In other embodiment(s), various components of the distributed file system can be included in a host application, a client application, storage/data services (e.g., 216 (see below)), etc.

The OneFS™ file system can comprise storage/data services (e.g., 216) and storage devices (e.g., 222) (e.g., comprising storage media, physical magnetic disk media, solid-state drive (SSD) media, e.g., flash storage, etc.) of a storage cluster (e.g., 102). In this regard, the OneFS™ file system is a type of clustered file system that spreads data across multiple storage nodes, e.g., usually for redundancy or performance. Further, such clustered file system can simultaneously be mounted on multiple file servers (not shown), e.g., OneFS™clusters, and can provide features like location-independent addressing and redundancy which can improve reliability and/or reduce the complexity of portion(s) of a data cluster, data storage cluster, etc.

The storage/data service(s) and storage device(s) can be included in respective data storage nodes of data storage clusters, e.g., combined as an integrated system—with no access to the storage devices other than through the OneFS™ file system. Each cluster creates a single namespace and file system. This means that the file system is distributed across all nodes in the cluster and is accessible by clients connecting to any node in the cluster. In this regard, data storage nodes of a data cluster must be communicatively and/or operatively connected, coupled, etc. together with a high performance, low-latency back-end network for optimal performance, e.g., based on a defined maximum communication latency between the storage nodes. In turn, data/storage service(s) comprising respective processes, processing jobs, job worker processes, applications, etc. can be utilized to service user requests according to user-based data/storage policies. In general, the respective data storage nodes can communicate with user devices via wired and/or wireless communication network(s) to provide access to services.

The OneFS™ file system can support storage, manipulation, and/or analysis of unstructured data on a massive scale on commodity hardware. As an example, the OneFS™ file system can support mobile, cloud, big data, and/or social networking applications. In another example, the OneFS™ file system can be deployed as a turnkey storage appliance, or as a software product that can be installed on a set of qualified commodity servers and disks, e.g., within a node, data storage node, etc. of a cluster, data storage cluster, etc. In this regard, the OneFS™ file system can comprise a cloud platform that comprises at least the following features: (i) lower cost than public clouds; (ii) unmatched combination of storage efficiency and data access; (iii) anywhere read/write access with strong consistency that simplifies application development; (iv) no single point of failure to increase availability and performance; (v) universal accessibility that eliminates storage silos and inefficient extract, transform, load (ETL)/data movement processes; etc.

Referring again to FIGS. 1 and 2, the distributed file system can comprise a cluster, storage cluster, etc. (102) comprising a group of nodes, storage nodes, etc. (104(1), 104(2), etc.) comprising respective compute resources (218, 220, 222, etc.). In this regard, the respective compute resources are present on each node of the group of nodes of the cluster, and in embodiment(s), can be aggregated, via the OneFS™ file system, into respective singular globally accessible pools of resources, e.g., a disk storage pool comprising a group of disk storage devices performing as a unified storage device, etc.

Further, a node of the group of nodes of the cluster can comprise a secure remote services component (110) that can facilitate reduction of contention of system resources when gathering performance, usage, and configuration data of the distributed file system—such data enabling clients of the OneFS™ file system, e.g., client service device (240), to effectively obtain information, telemetry data, etc. of the cluster in order make informed decisions regarding performance of the distributed file system.

In one embodiment, the node can be elected, based on an election algorithm, as a master, leader, coordinator, etc. node comprising the secure remote services component—performing operations of the secure remote services component described below via the master, leader, coordinator, etc. node.

In this regard, the secure remote services component determines, based on a configuration file (108), different times to initiate respective sampling of defined attributes of respective defined resource types according to defined sampling intervals that have been specified by the configuration file. In embodiment(s), the secure remote services component utilizes a random number function to randomly determine, within defined increments, e.g., 5 minute increments, the different times, and generate, based on the different times, a schedule for initiating the respective sampling of the defined attributes - assigning the different times to respective increments, e.g., 5 minute increments, of the defined increments.

Based on the schedule, the secure remote services component initiates, at the different times, the respective sampling of the defined attributes of the respective defined resource types. In embodiment(s), the secure remote services component initiates sampling, obtaining, determining, etc. a defined attribute of a defined resource type of the respective defined resource types by sending a request to obtain the defined attribute to a platform application programming interface (PAPI) (106(1), 106(2), etc.) of a node comprising, corresponding to, etc. the defined resource type.

In turn, in response to receiving, from the PAPI, of the node, unstructured data corresponding to the defined attribute, the secure remote services component creates structured data comprising the unstructured data and metadata representing the unstructured data. For example, the structured data comprises a cluster identifier representing the cluster, an attribute identifier representing the defined attribute, or a period of time during which the defined attribute was obtained via, by, etc. the secure remote services component.

Table 1 below illustrates an example configuration file:

TABLE 1
{
5 minutes: {

| performance: [ | |
|---|---|
| node.cpu.avg, | -- average CPU usage for each node |
| node.health | -- health score for each node |
| ], | |
| usage: [ | |
| cluster.bytes.total, | -- total capacity |

| | |
|---|---|
| cluster.bytes.used, | -- total used capacity |
| node.memory.total, | -- total RAM for each node |
| node.memory.used | -- total RAM used for each node |

]

```
  },
  daily: {
```

| configuration: [ | |
|---|---|
| node.cpu.count, | -- number of CPUs in each node |
| protocols.ftp.settings, -- current FTP settings | |
| protocols.nfs.settings -- current NFS settings | |
| ], | |
| usage: [ | |
| node.uptime | -- how long each node has been running |

]

}
}

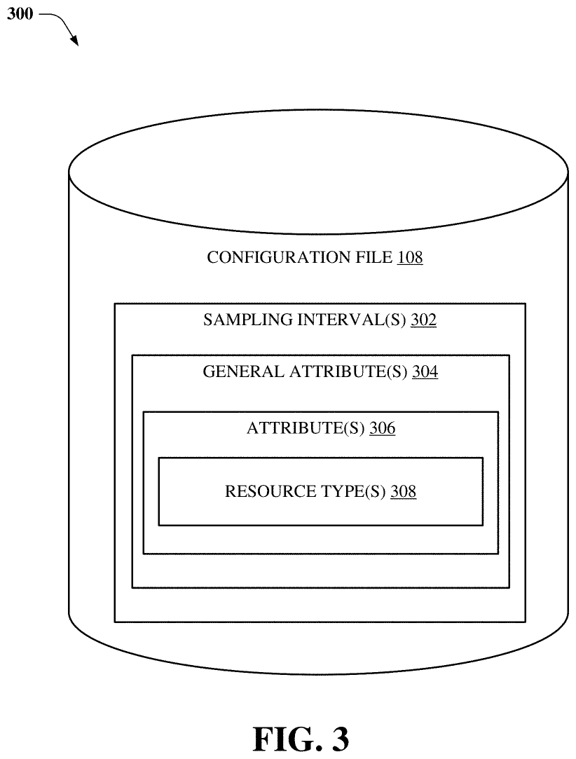

In this regard, as illustrated by FIG. 3, the configuration file (108) can define sampling intervals (302) for respectively obtaining general attribute(s) (304) comprising defined attributes (306) of respective defined resource types (308) of the respective compute resources.

In an embodiment, a defined resource type of the respective defined resource types comprises the cluster or a node of the group of nodes. In another embodiment, the defined resource type comprises a disk storage pool. In yet another embodiment, the defined resource type comprises a service, storage service, data service, etc.

In this regard, the general attributes comprise a performance attribute of the defined resource type, a usage attribute of the defined resource type, and/or a configuration attribute of the defined resource type.

In embodiment(s), the performance attribute comprises a CPU use of the defined resource type, an average CPU use of the defined resource type, or a resource health score of the defined resource type, e.g., the resource health score representing a percentage of disks, storage disks, etc. of the cluster that are online; a number of the disks, storage disks, etc. that are online, etc.

In yet other embodiment(s), the usage attribute comprises a total storage capacity of the defined resource type, a storage amount of the total storage capacity that is being used, a total memory capacity of the defined resource type, an amount of the total memory capacity that is being used, or an uptime of the defined resource type representing a duration of time that the defined resource type, e.g., disk, service, etc. has been in use, operating, etc.

In embodiment(s), the configuration attribute comprises a number of CPUs corresponding to, that have been assigned to, etc. the defined resource type; a network protocol (e.g., network file system (NFS) protocol, file transfer protocol (FTP), server message block (SMB) protocol, etc.) attribute of the defined resource type; a hypertext transfer protocol (HTTP) attribute of the defined resource type; or a distributed file system (DFS) attribute of the defined resource type.

In an embodiment, the network protocol attribute can represent an amount of processing capabilities of a CPU, etc. that an NFS is enabled to use, is currently using, etc.

In one embodiment, the HTTP attribute can represent a defined maximum number of HTTP clients that are permitted to be executing via a client service device (240), etc.

In another embodiment, the DFS attribute can specify whether a feature of the distributed file system is enabled, running, operating, etc. In yet another embodiment, the DFS attribute can specify whether a service, storage service, data service, etc. is enabled, running, operating, etc. In one embodiment, the DFS attribute can specify an amount, percentage, etc. of processing capabilities of a CPU that are being utilized.

Referring again to FIG. 2, in response to receiving, from the PAPI of the node, unstructured data corresponding to the defined attribute, the secure remote services component creates structured data comprising the unstructured data and metadata representing the unstructured data. For example, the structured data comprises a cluster identifier representing the cluster, an attribute identifier representing the defined attribute, or a period of time during which the defined attribute was obtained via, by, etc. the secure remote services component.

In embodiment(s), the distributed file system comprises an analysis component (230) that receives, from the secure remote services component, the structured data, and in response to a query for the defined attribute being received from a client service device (240), e.g., associated with a client service of a client of the distributed file system, sends the structured data representing the defined attribute to the client service device.

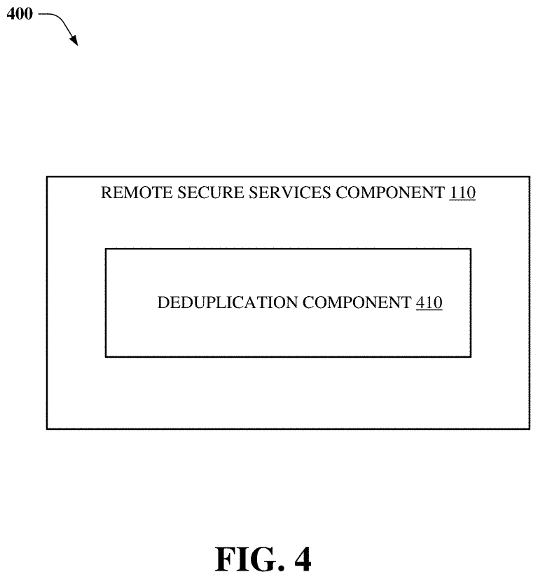

Now referring to embodiment(s) illustrated by FIG. 4, the remote services component further comprises a deduplication component (410) that, in response to first unstructured data corresponding to a defined attribute of the defined attributes of a defined resource type of the respective defined resource types being obtained via a first sampling interval of the sampling intervals, performs a hash function on the first unstructured data to obtain a first hash value, stores the first hash value in a first portion of a memory of the distributed file system, e.g., a first part of a hash table (not shown), and stores a first time that the first hash value was obtained in a second portion of the memory, e.g., a second part of the hash table.

In this regard, the hash table maps, correlates, etc. structured data representing (e.g., as an identifier) the defined attribute to a hash value of unstructured data corresponding to, representing, etc. the defined attribute. In this regard, instead of consuming system resources, e.g., storage bandwidth, processing bandwidth, network bandwidth, etc. by storing a value of the defined attribute, the deduplication component stores a computed form, i.e., hash, of the value in a fixed amount of memory space dedicated to representing the defined attribute.

In embodiment(s), in response to second unstructured data corresponding to the defined attribute being obtained via a second sampling interval of the sampling intervals, the deduplication component performs the hash function on the second unstructured data to obtain a second hash value. In this regard, in response to the first hash value being determined to be equal to the second hash value, the deduplication component stores a second time that the second hash value was obtained in the second portion of the memory—preserving system resources by not re-storing a value that hasn't changed, while storing only the latest sampling time of the value; otherwise, in response to the first hash value being determined to be different than the second hash value, the deduplication component stores the second hash value in the first portion of the memory, and stores the second time in the second portion of the memory.

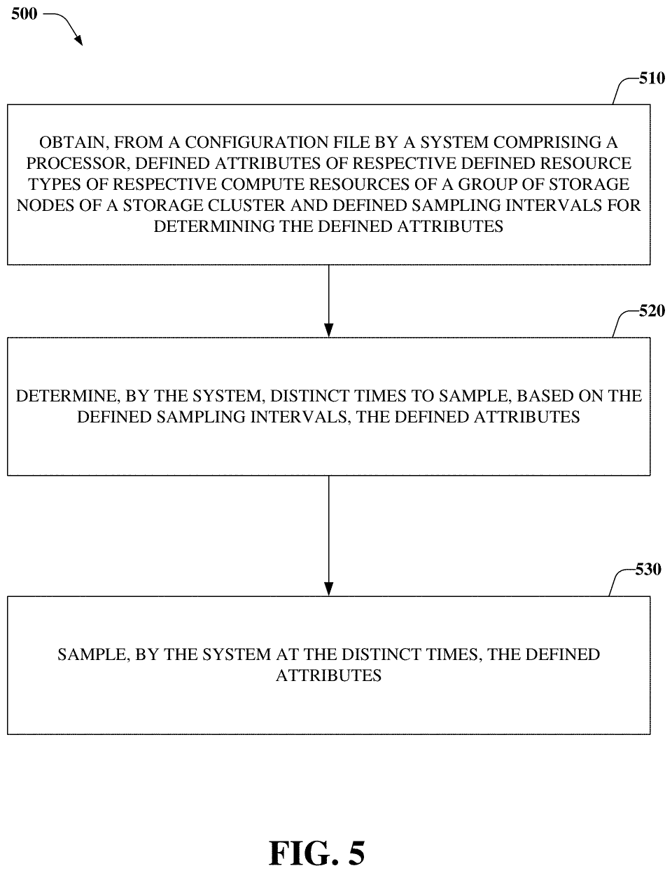

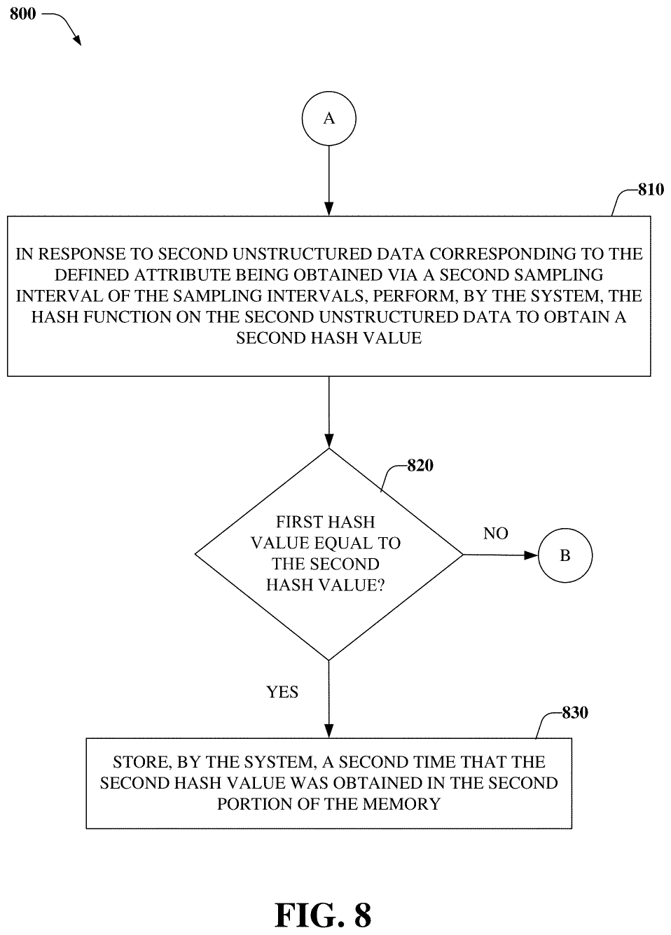

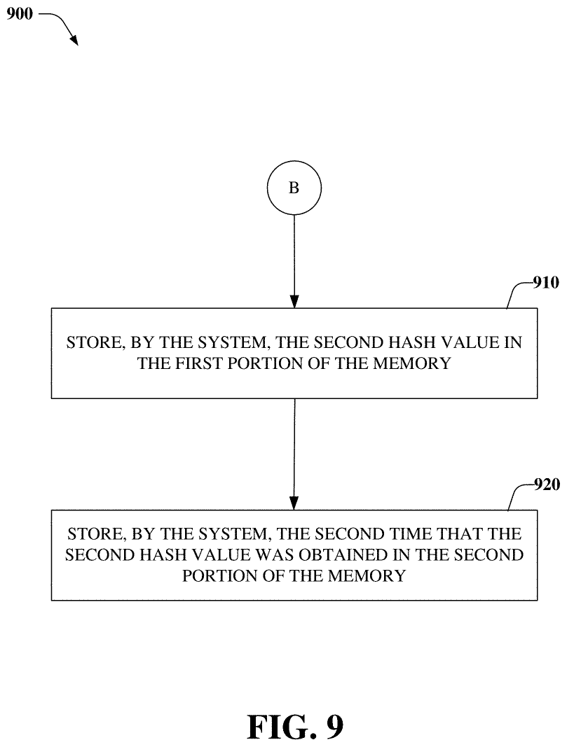

FIGS. 5-9 illustrate methodologies for performing operations corresponding to gathering data of a distributed system based on defined sampling intervals that have been respectively initiated by such system to minimize contention of system resources, in accordance with various example embodiments. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 5, a flowchart of a method associated with gathering data of system resources based on defined sampling intervals that have been respectively initiated by such system to minimize contention of the system resources is illustrated, in accordance with various example embodiments. At 510, a system, e.g., distributed file system (100) comprising a processor, obtains, from a configuration file, defined attributes of respective defined resource types of respective compute resources of a group of storage nodes of a storage cluster and defined sampling intervals for determining the defined attributes.

At 520, the system determines distinct times to sample, based on the defined sampling intervals, the defined attributes. For example, in embodiment(s), the system determines the distinct times using a random number function—the distinct times comprising randomly generated times. In turn, at 530, the system samples, at the distinct times, the defined attributes.

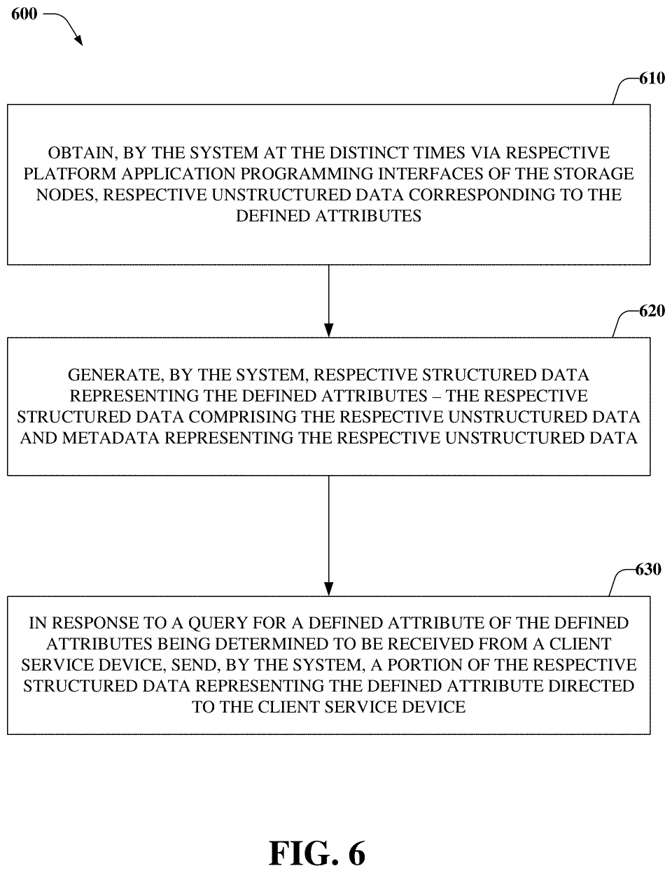

FIG. 6 illustrates a flow chart of another method associated with gathering data of system resources based on defined sampling intervals that have been respectively initiated by such system to minimize contention of the system resources, in accordance with various example embodiments. At 610, the system obtains, at the distinct times via respective platform application programming interfaces (PAPIs) of the storage nodes, respective unstructured data corresponding to the defined attributes. At 620, the system generates respective structured data representing the defined attributes—such data comprising the respective unstructured data and metadata representing the respective unstructured data. At 630, in response to a query for a defined attribute of the defined attributes being determined to be received from a client service device, the system sends a portion of the respective structured data representing the defined attribute directed to the client service device.

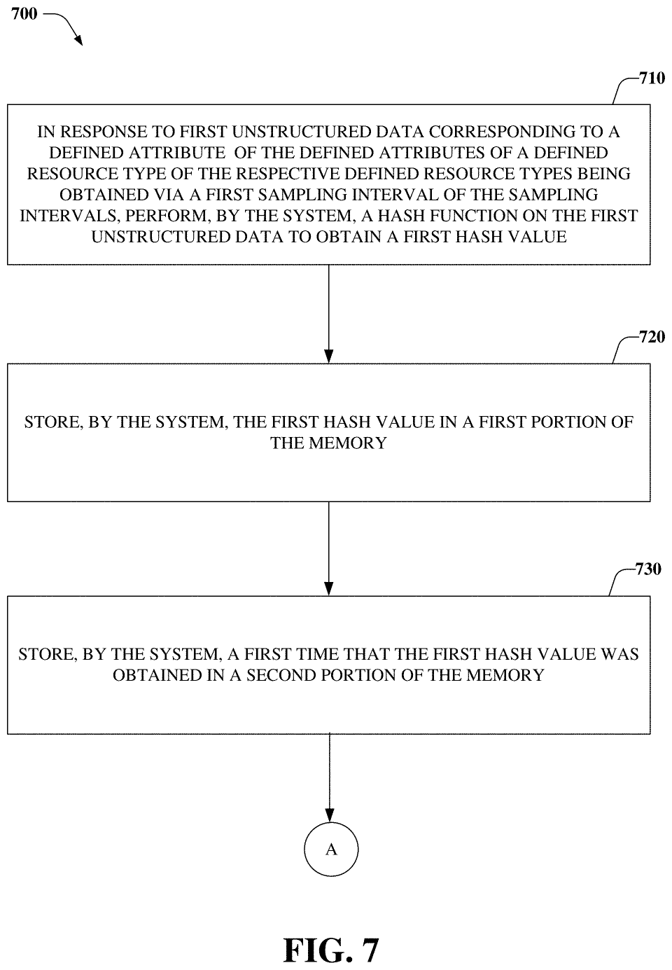

FIGS. 7-9 illustrate flow charts of a method associated with a deduplication component (410) that facilitates reducing system costs associated with communicating results that haven't changed between sampling periods, in accordance with various example embodiments. At 710, in response to first unstructured data corresponding to a defined attribute of the defined attributes of a defined resource type of the respective defined resource types being obtained via a first sampling interval of the sampling intervals, the system performs, executes, etc. a hash function on the first unstructured data to obtain a first hash value.

At 720, the system stores the first hash value in a first portion of a memory of the system. Further, at 730, the system stores a first time that the first hash value was obtained in a second portion of the memory. At 810, in response to second unstructured data corresponding to the defined attribute being obtained via a second sampling interval of the sampling intervals, the system performs, executes, etc. the hash function on the second unstructured data to obtain a second hash value.

At 820, the system determines whether the first hash value is equal to the second hash value. In this regard, in response to the first hash value being determined to be equal to the second hash value, the system stores, at 830, a second time that the second hash value was obtained in the second portion of the memory—without restoring the second hash value that hasn't changed; otherwise flow continues to 910, at which the system stores the second hash value in the first portion of the memory—replacing the first hash value representing the first unstructured data. Further, at 920, the system stores the second time that the second hash value was obtained in the second portion of the memory.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic”, “logical”, “logically”, and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component”, “system”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

As it is employed in the subject specification, the term “processor” and “computer processing unit” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “cluster”, “storage cluster”, “node”, “storage node”, “storage devices”, “data storage”, “storage device”, “storage medium”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in RAM (220), disks (222), non-volatile memory 1022 (see below), disk storage 1024 (see below), and/or memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory 1020 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

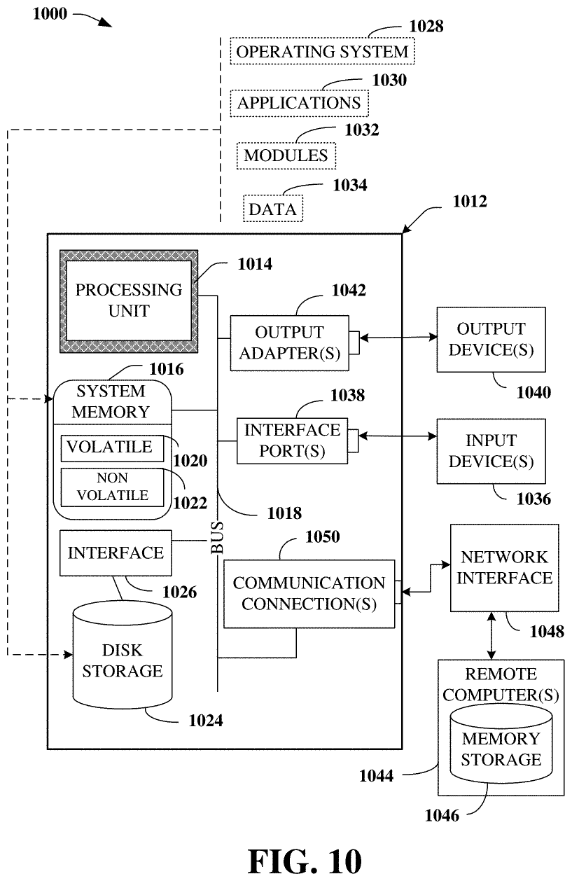

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 10, a block diagram of a computing system 1000, e.g., distributed file system 100, operable to execute the disclosed systems and methods is illustrated, in accordance with an embodiment. Computer 1012 comprises a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1016 comprises volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can comprise ROM, PROM, EPROM, EEPROM, or flash memory. Volatile memory 1020 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also comprises removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, Jaz drive, Zip drive, LS-100 drive, flash memory card, or memory stick. In addition, disk storage 1024 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

It is to be appreciated that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be appreciated that the disclosed subject matter can be implemented with various operating systems or combinations of operating systems.

A user can enter commands or information into computer 1012 through input device(s) 1036. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1014 through system bus 1018 via interface port(s) 1038. Interface port(s) 1038 comprise, for example, a serial port, a parallel port, a game port, a universal serial bus (USB), a wireless based port, e.g., Wi-Fi, Bluetooth, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040, like display devices, light projection devices, monitors, speakers, and printers, among other output devices 1040, which use special adapters. Output adapters 1042 comprise, by way of illustration and not limitation, video and sound devices, cards, etc. that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, a workstation, a microprocessor based appliance, a peer device, or other common network node and the like, and typically comprises many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically and/or wirelessly connected via communication connection 1050. Network interface 1048 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and DSL modems, wireless modems, ISDN adapters, and Ethernet cards.

The computer 1012 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1012 can connect to other devices/networks by way of antenna, port, network interface adaptor, wireless access point, modem, and/or the like.

The computer 1012 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wireles sly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor;
a configuration file that defines sampling intervals for respectively obtaining defined attributes of respective defined resource types of respective compute resources of a group of storage nodes of a storage cluster; and
a memory that stores executable components that, when executed by the processor, facilitate performance of operations by the system, the executable components comprising:
a secure remote services component that
determines, based on the configuration file, different times to initiate the respectively obtaining the defined attributes of the respective defined resource types according to the sampling intervals, and
at the different times, initiates the respectively obtaining the defined attributes of the respective defined resource types according to the sampling intervals.

2. The system of claim 1, wherein the secure remote services component further:
obtains unstructured data corresponding to the defined attributes, and
creates respective structured data representing the defined attributes, the respective structured data comprising the unstructured data and respective metadata representing the unstructured data.

3. The system of claim 2, wherein the respective structured data comprises at least one of a storage cluster identifier representing the storage cluster, an attribute identifier representing a defined attribute of the defined attributes, or a period of time during which the defined attribute was obtained by the secure remote services component.

4. The system of claim 2, wherein the executable components further comprise:
an analysis component that
receives, from the secure remote services component, the respective structured data, and
in response to a query for a defined attribute of the defined attributes being received from a client service device, sends a portion of the respective structured data representing the defined attribute to the client service device.

5. The system of claim 2, wherein the remote services component further comprises:
a deduplication component that
in response to first unstructured data corresponding to a defined attribute of the defined attributes of a defined resource type of the respective defined resource types being obtained via a first sampling interval of the sampling intervals, performs a hash function on the first unstructured data to obtain a first hash value,
stores the first hash value in a first portion of the memory, and
stores a first time that the first hash value was obtained in a second portion of the memory.

6. The system of claim 5, wherein the deduplication component further:
in response to second unstructured data corresponding to the defined attribute being obtained via a second sampling interval of the sampling intervals, performs the hash function on the second unstructured data to obtain a second hash value, and
in response to the first hash value being determined to be equal to the second hash value, stores a second time that the second hash value was obtained in the second portion of the memory.

7. The system of claim 6, wherein the deduplication component further:
in response to the first hash value being determined to be different than the second hash value,
stores the second hash value in the first portion of the memory, and
stores the second time that the second hash value was obtained in the second portion of the memory.

8. The system of claim 1, wherein the defined attributes comprise at least one of a performance attribute of a defined resource type of the respective defined resource types, a usage attribute of the defined resource type, or a configuration attribute of the defined resource type.

9. The system of claim 8, wherein the defined resource type comprises the storage cluster or a storage node of the group of storage nodes.

10. The system of claim 8, wherein the performance attribute comprises a computer processing unit use of the defined resource type, an average computer processing unit use of the defined resource type, or a resource health score of the defined resource type.

11. The system of claim 8, wherein the usage attribute comprises a total storage capacity of the defined resource type, a storage amount of the total storage capacity that is being used, a total memory capacity of the defined resource type, a memory amount of the total memory capacity that is being used, or an uptime of the defined resource type representing a duration of time that the defined resource type has been in use.

12. The system of claim 8, wherein the configuration attribute comprises a number of computer processing units corresponding to the defined resource type, a network protocol attribute of the defined resource type, or a distributed file system attribute of the defined resource type.

13. The system of claim 8, wherein the respective compute resources comprise respective computer processing units, respective volatile memory devices, and respective memory devices, and wherein the defined resource type comprises
a group of computer processing units of the respective computer processing units,
a group of volatile memory devices of the respective volatile memory devices, or
a group of memory devices of the respective memory devices.

14. The system of claim 1, wherein a storage node of the group of storage nodes has been elected, based on an election algorithm, as a master storage node comprising the secure remote services component.

15. The system of claim 1, wherein the secure remote services component further determines, based on the configuration file, random times to initiate the respectively obtaining the defined attributes of the respective defined resource types according to the sampling intervals.

16. A method, comprising:
obtaining, from a configuration file by a system comprising a processor, defined attributes of respective defined resource types of respective compute resources of a group of storage nodes of a storage cluster and defined sampling intervals for determining the defined attributes;
determining, by the system, distinct times to sample, based on the defined sampling intervals, the defined attributes; and
sampling, by the system at the distinct times, the defined attributes.

17. The method of claim 16, wherein the sampling comprises:
obtaining, at the distinct times via respective platform application programming interfaces of the storage nodes, respective unstructured data corresponding to the defined attributes; and
generating respective structured data representing the defined attributes, wherein the respective structured data comprises the respective unstructured data and metadata representing the respective unstructured data.

18. The method of claim 16, further comprising:
in response to a query for a defined attribute of the defined attributes being determined to be received from a client service device, sending, by the system, a portion of the respective structured data representing the defined attribute directed to the client service device.

19. A machine-readable storage medium comprising instructions that, in response to execution, cause a storage node comprising a processor to perform operations, comprising:
retrieving, from a configuration file of the file system, defined attributes of respective defined resources of the file system and defined intervals for sampling the defined attributes;
determining disparate times to initiate the sampling the defined attributes of the respective defined resources based on the defined intervals; and
based on the disparate times, initiating the sampling the defined attributes of the respective defined resources based on the defined intervals to obtain respective unstructured data corresponding to the defined attributes.

20. The machine-readable storage medium of claim 19, wherein the operations further comprise:
in response to the sampling, generating structured data comprising the respective unstructured data and metadata representing the unstructured data.
